(19) United States
(12) Patent Application Publication
(10) Pub. No.: US 2007/0069097 A1
(43) Pub. Date: Mar. 29, 2007

(54) Mouse pad

(76) Inventor: Song-Yuan Hsieh, Hsinchu City (TW)

Correspondence Address: LIN & ASSOCIATES INTELLECTUAL PROPERTY, P.O. BOX 2339, SARATOGA, CA, 95070-0339, US

(21) Appl. No.: 11/238,809

(22) Filed: Sep. 29, 2005

(51) Int. Cl. B32B 33/00

(52) U.S. Cl. 248/346.01; 248/918; 428/40.1; 428/172

(57) ABSTRACT

A mouse pad for supporting a mouse device in a computer system is provided with a bottom silicon rubber layer and a top abrasion resistant layer. The abrasion resistant layer is made of polyurethane (PU) material. The mouse pad is thin in structure and resistant to abrasion, and feels good to the touch.

### FIELD OF THE INVENTION

The present invention generally relates to a mouse pad, and more specifically to a gel mouse pad with a top polyurethane (PU) layer.

### BACKGROUND OF THE INVENTION

As the notebook PC and the wireless broadband internet access become ubiquitous, users can use their notebook PC anywhere, such as living room, kitchen, outdoor balcony or patio, or even restaurants or cafe. Carrying their notebook computers and access internet anywhere is becoming a part of life style. Although most notebook PC have built-in touch pad, most users are costumed to using a mouse with a USB port. On these occasions, a well design mouse pad is an essential part for the overall convenience and work efficiency.

The gel mouse pad has gained much popularity in recent years. Some of the gel mouse pads are completely made of silicon gel, while others use a multi-layer structure. Each type has respective advantages and disadvantages. However, it is imperative to have a mouse pad that is convenient to use and well-designed to suit various working conditions.

### SUMMARY OF THE INVENTION

The primary object of the present invention is to provide a mouse pad. The main feature of the present invention is to add an abrasion resistant layer made of the polyurethane (PU) material on top of the bottom gel layer. The soft gel layer provides a better gripping to the table surface so that the mouse pad will not move or slide along with the mouse. The top PU abrasion resistant layer has suitable hardness and abrasion resistance so that the mouse can move on the mouse pad with more ease and stability.

Another object of the present invention is to provide a mouse pad that is easy to carry. As the overall thickness of the mouse pad of the present invention can be controlled under 1 mm, and the soft material is bendable, the mouse pad of the present invention can be easily carried around, or even slide between the screen and the keyboard of a notebook PC. This design provides good flexibility and convenience for the notebook PC users.

To achieve the aforementioned objects, the present invention provides a mouse pad with a gel bottom layer and a thin top abrasion layer made of a PU material.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the present invention;

FIG. 2 shows a cross-sectional view of present invention; and

FIG. 3 shows a manufacturing flowchart of the present invention.

### DETAILED DESCRIPTION OF THE PREFERRED EMBODIMENTS

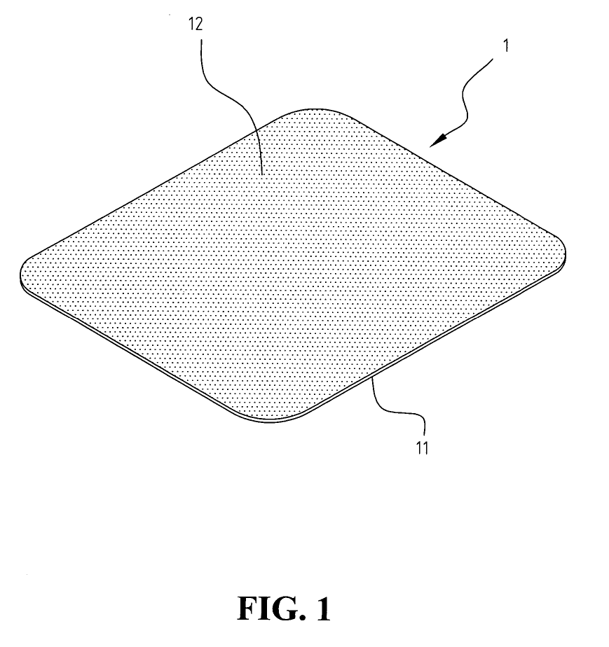

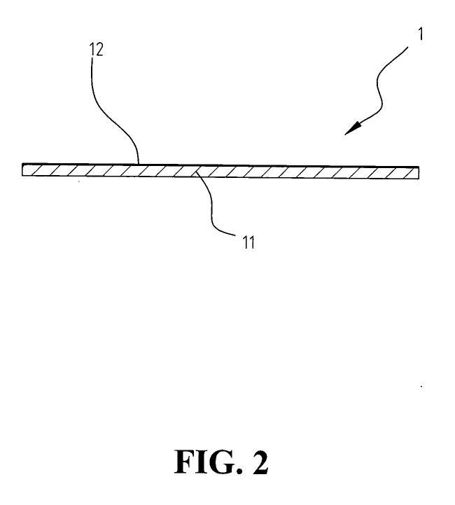

FIG. 1 and FIG. 2 show a schematic view and a cross-sectional view of the present invention, respectively. A mouse pad 1 includes a silicon gel layer 11. The thickness of gel layer 11 is at least 95% of the overall thickness of mouse pad 1. Silicon gel is a soft material, and feels good to the touch. In addition, silicon gel provides better gripping to the table surface so that mouse pad 1 will not move or slide during the mouse movement. Mouse pad 1 also includes a thin top abrasion resistant layer 12, which is made of polyurethane (PU) material. The PU material is relatively hard, compared to silicon gel; therefore, abrasion resistant layer 12 provides better surface for the move movement and extends the life span of mouse pad 1.

To make the mouse movement even better, abrasion resistant layer 12 can be made as a non-smooth surface, such as slightly coarse surface, special patterned or tiny wrinkles, and so on. The purpose is to leave a tiny space between the bottom of the mouse and abrasion resistant layer 12 so that the mouse can move more easily.

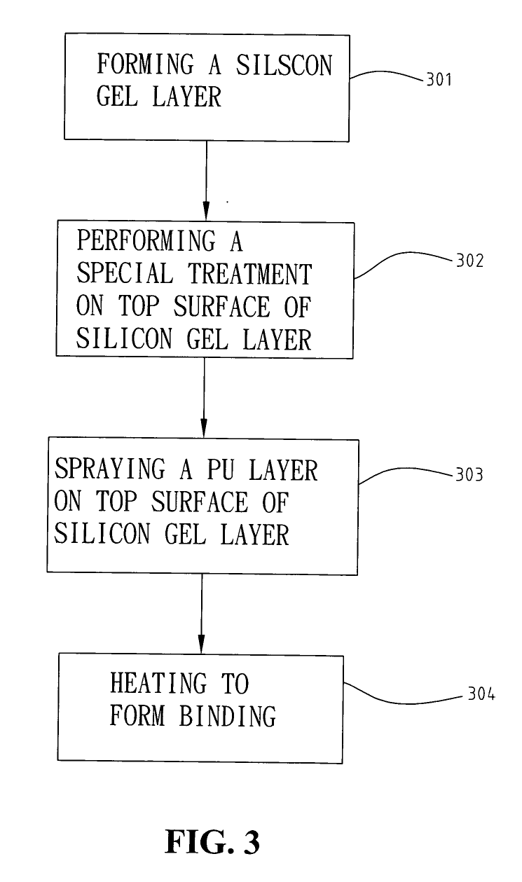

FIG. 3 shows a manufacturing flowchart of the present invention. Step 301 is to press the silicon gel into a layer of desired shape and size. During this step, the surface of the mold is prepared with a texture process so that the top surface of the gel layer is non-smooth. Step 302 is to treat the top surface of the gel layer with a special process to increase the surface adhesion for later steps. Step 303 is to spray a layer of PU material on top of the top surface of the gel layer. Finally, step 304 is to heat the gel layer and the PU layer to a pre-determined temperature to bind the gel layer and the PU layer together to form a mouse pad.

The mouse pad of the present invention provides the following advantages:

1. The overall thickness can be easily controlled under 1 mm, so that it is easy for storage or carrying to meet the use-anywhere demand.

2. The high quality silicon gel layer provides better touch to the user and better movement for the mouse.

3. It is easy to clean because the top PU layer can be easily watch or wiped with water.

4. The mouse pad is suitable for mechanical mouse or optical mouse.

5. It is easy to manufacture, high quality, low in cost, and has a strong market appeal.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1-2. (canceled)

3. A mouse pad for supporting a mouse device in a computer system, comprising:
a bottom layer made of rubber silicon; and
a top abrasion resistant layer coated on top of said bottom layer, said top abrasion resistant layer being made of polyurethane (PU) material;
wherein said top abrasion resistant layer provides a coarse surface for said mouse device to move around.

4. The mouse pad as claimed in claim 3, wherein said top abrasion resistant layer has a non-smooth surface.

5. The mouse pad as claimed in claim 3, wherein said bottom layer has a non-smooth top surface.

6. The mouse pad as claimed in claim 3, wherein said mouse pad has a thickness less than 1 mm.
